(19) United States
(12) Patent Application Publication
(10) Pub. No.: US 2011/0013722 A1
(43) Pub. Date: Jan. 20, 2011

(54) Method for Generating Training Sequences and Transmitter Using the Same

(76) Inventors: Cheng-Hsuan Wu, Taipei City (TW); Yen-Chin Liao, Taipei City (TW); Yung-Szu Tu, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/836,590

(22) Filed: Jul. 15, 2010

Related U.S. Application Data
(60) Provisional application No. 61/225,931, filed on Jul. 16, 2009.

(30) Foreign Application Priority Data
Nov. 25, 2009 (TW) 098140123

(51) Int. Cl. H04L 27/00

(52) U.S. Cl. 375/295

(57) ABSTRACT

A method for generating training sequences in a transmitter having a plurality of transmitting antennas, includes dividing each of a plurality of symbols into a plurality of sub-symbols with a quantity equal to a quantity of the plurality of transmitting antennas, sequentially transforming a plurality of sub-symbols corresponding to same positions in each of the plurality of symbols, to generate a plurality of training data, and generating a plurality of training sequences of independent frequencies according to the plurality of training data, for forming parts of packets emitted by the plurality of transmitting antennas.

### CROSS REFERENCE TO RELATED APPLICATIONS

This application claims the benefit of U.S. Provisional Application No. 61/225,931, filed on Jul. 16, 2009 and entitled “WIRELESS TRANSMISSION METHOD AND DEVICE USING THE SAME”, the contents of which are incorporated herein.

### BACKGROUND OF THE INVENTION

1. Field of the Invention

The present invention relates to a method for generating training sequences in a wireless communication system and a transmitter using the same, and more particularly, to a method capable of effectively reducing data needed for channel estimation and a transmitter using the same0.

2. Description of the Prior Art

Orthogonal frequency division multiplexing (OFDM) modulation technology is one of multi carrier modulation (MCM) transmission methods, with a basic concept of dividing a data stream of high transmission rate into several parallel sub-streams of low transmission rates, and modulating each sub-stream to different sub-carriers. Under the circumstances, a symbol time becomes so long that a delay induced by a channel affects a small part of the symbol time. Thus, inter symbol interference can be eliminated or reduced, and spectrum efficiency can be effectively enhanced, so as to increase data throughput. As a result, OFDM modulation technology has been widely used in many wireless communication systems, such as wireless local area network (WLAN), and the related WLAN communication protocols such as IEEE 802.11a, IEEE 802.11b, IEEE 802.11g, and IEEE 802.11n all adopt OFDM modulation technology. Different to IEEE 802.11a/g standards, IEEE 802.11n standard further utilizes multiple input multiple output (MIMO) technology and other new approaches to substantially enhance data rate and throughput, and meanwhile, increases channel bandwidth from 20 MHz to 40 MHz.

In a typical MIMO OFDM system as shown in FIG. 1, a transmitter and a receiver perform wireless signal transmissions via multiple antennas, and before performing transmission, the transmitter and the receiver are not able to obtain information of a channel status. Hence, estimating the channel status is of extreme importance.

In general, in the multi-patterns OFDM system shown in FIG. 1, channel estimation is performed with training sequences. First, the transmitter sends training sequences or generates training fields carried by packets. When receiving the training sequences or the training fields, the receiver performs channel estimation accordingly, to determine the channel status.

For example, Please refer to FIG. 2, which is a schematic diagram of an IEEE 802.11n packet according to the prior art. As shown in FIG. 2, the IEEE 802.11n packet consists of a preamble portion carrying preamble data and a payload portion carrying data to be transmitted. The preamble data is of a mixed format, is backward compatible with IEEE 802.11a/g standard devices, and includes, in sequence, legacy short training field L-STF, legacy long training field L-LTF, legacy signal field L-SIG, high-throughput signal field HT-SIG, high-throughput short training field HT-STF, and N pieces of high-throughput long training fields HT-LTF. The legacy short training field L-STF is used for start-of-packet detection, automatic gain control (AGC), initial frequency offset estimation, and initial time synchronization. The legacy long training field L-LTF is used for further fine frequency offset estimation and time synchronization. The legacy signal field L-SIG carries information of data rate and packet length. The high-throughput signal field HT-SIG also carries data rate information, and is used for packet detection, so that the mixed format or the legacy format the transmitted packet uses can be detected. The high-throughput short training field HT-STF is used for automatic gain control. The high-throughput long training fields HT-LTF are used for MIMO channel detection, enabling receivers to determine channel status accordingly.

Patterns of the high-throughput long training fields HT-LTF are well-known for those skilled in the art, and are not narrated herein. Functionally, the high-throughput long training fields HT-LTF can be further divided in two categories. The first category refers to data high-throughput long training fields, for estimating a channel status used by current data, with a quantity N_{DLTF} determined by a quantity N_{STS} of space time streams, as illustrated in FIG. 4. The second catalog refers to extension high-throughput long training fields, for detecting extra spatial dimensions of channels not in use, with a quantity N_{ELTF} determined by a quantity N_{ESS} of extra spatial dimensions to be detected. A reference table of N_{ELTF} and N_{ESS} is identical to that of N_{DLTF} and N_{STS} as illustrated in FIG. 3. In addition, IEEE 802.11n standard supports upmost four antennas, and hence, N_{DLTF} and N_{ELTF} are smaller or equal to 4.

On the other hand, in order to reduce the complexity of channel estimation, the high-throughput long training fields HT-LTF are designed to be generated by giving weightings and delays to a single symbol in the prior art, which is done by multiplying the high-throughput long training fields HT-LTF with a spreading code matrix to generate independent phases. Accordingly, the receiver can perform channel estimation. With the development of very high throughput (VHT) wireless communication technology, next-generation WLAN standard IEEE 802.11ac provides larger channel bandwidth (80 MHz), and supports more than 4 antennas. Under the circumstances, the design of the high-throughput long training fields has become a critical issue. However, the prior art mechanism of using the spreading code matrix to transform the high-throughput long training fields can substantially increases overhead, i.e. data-to-be-transmitted, under a multi-antenna structure (with more than four antennas). Therefore, it is necessary to design a new method for generating long training fields, so as to facilitate realization of the next-generation WLAN standard.

### SUMMARY OF THE INVENTION

Therefore, the present invention provides a method for generating training sequences in wireless communication system and a transmitter using the method.

The present invention discloses a method for generating training sequences in a transmitter having a plurality of transmitting antennas, which comprises dividing each of a plurality of symbols into a plurality of sub-symbols with a quantity equal to a quantity of the plurality of transmitting antennas, sequentially transforming a plurality of sub-symbols corresponding to same positions in each of the plurality of symbols, to generate a plurality of training data, and generating a plurality of training sequences of independent frequencies according to the plurality of training data, for forming parts of packets emitted by the plurality of transmitting antennas.

The present invention further discloses a transmitter having a plurality of transmitting antennas in a wireless communication system, which comprises a microprocessor, and a memory, for storing a program, for instructing the microprocessor to execute the following steps: dividing each of a plurality of symbols into a plurality of sub-symbols with a quantity equal to a quantity of the plurality of transmitting antennas, sequentially transforming a plurality of sub-symbols corresponding to same positions in each of the plurality of symbols, to generate a plurality of training data, and generating a plurality of training sequences of independent frequencies according to the plurality of training data, for forming parts of packets emitted by the plurality of transmitting antennas.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional MIMO OFDM system.

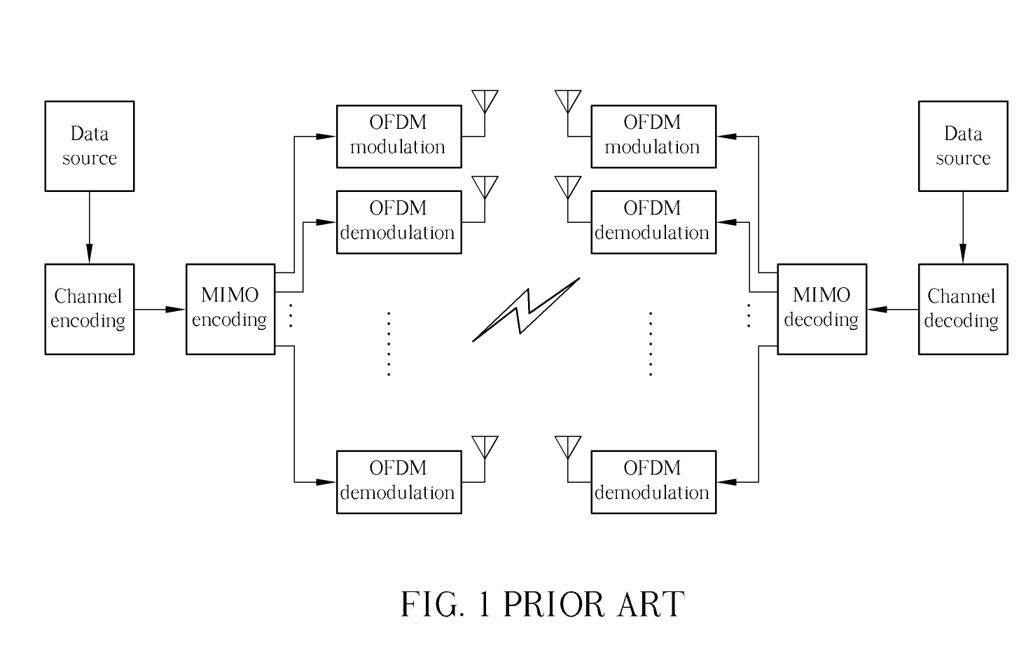

FIG. 2 is a schematic diagram of an IEEE 802.11n packet according to the prior art.

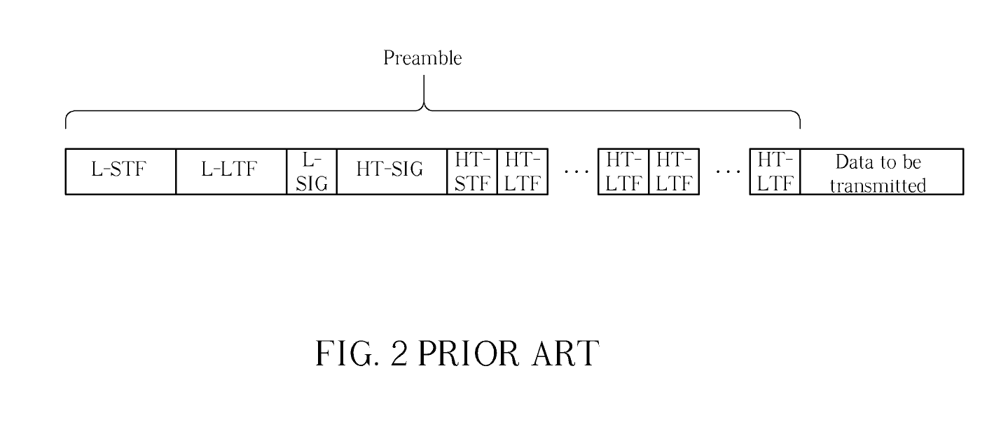

FIG. 3 is a schematic diagram of a reference table for determining a quantity of high-throughput long training fields according to the prior art IEEE 802.11n standard.

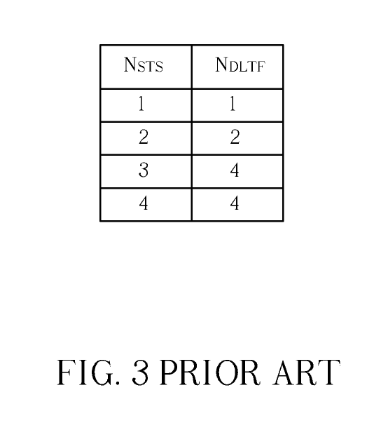

FIG. 4 is a schematic diagram of a training sequence generating process according to an embodiment of the present invention.

FIG. 5 is a schematic diagram of generating training data by the training sequence generating process shown in FIG. 4.

FIG. 6 is a schematic diagram of generating training sequences with the training data shown in FIG. 5.

FIG. 7 is a schematic diagram of a channel estimation result according to an embodiment of the present invention.

FIG. 8 is a schematic diagram of an embodiment of generating training sequences.

### DETAILED DESCRIPTION

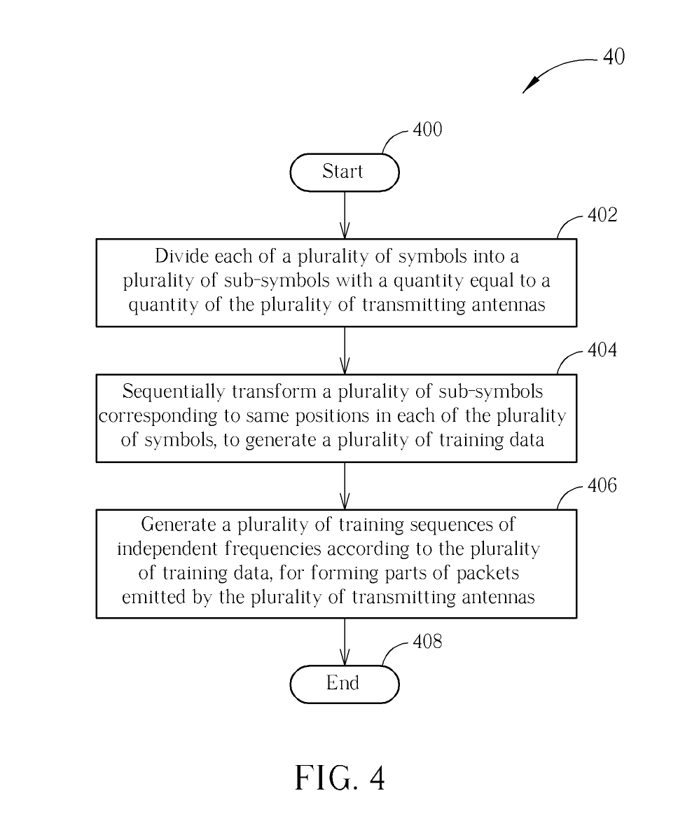

Please refer to FIG. 4. FIG. 4 is a schematic diagram of a training sequence generating process 40 used in a transmitter of a wireless communication system according to an embodiment of the present invention. The wireless communication system is a MIMO OFDM system, and that is, the transmitter comprises a plurality of transmitting antennas. The training sequence generating process 40 is utilized for generating training sequence, and comprises the following steps:

Step 400: Start.

Step 402: Divide each of a plurality of symbols into a plurality of sub-symbols with a quantity equal to a quantity of the plurality of transmitting antennas.

Step 404: Sequentially transform a plurality of sub-symbols corresponding to same positions in each of the plurality of symbols, to generate a plurality of training data.

Step 406: Generate a plurality of training sequences of independent frequencies according to the plurality of training data, for forming parts of packets emitted by the plurality of transmitting antennas.

Step 408: End.

According to the training sequence generating process 40, the present invention divides each symbol into multiple sub-symbols with a quantity equal to the quantity of the transmitting antennas. Then, the present invention sequentially performs transformation, such as an inverse discrete Fourier transform, on sub-symbols corresponding to same positions in all symbols, to transform frequency domain data to time domain data, and generate training data accordingly. Finally, the present invention adequately arranges the obtained training data, to generate training sequences of independent frequencies, which are respectively carried by packets emitted by the transmitting antennas.

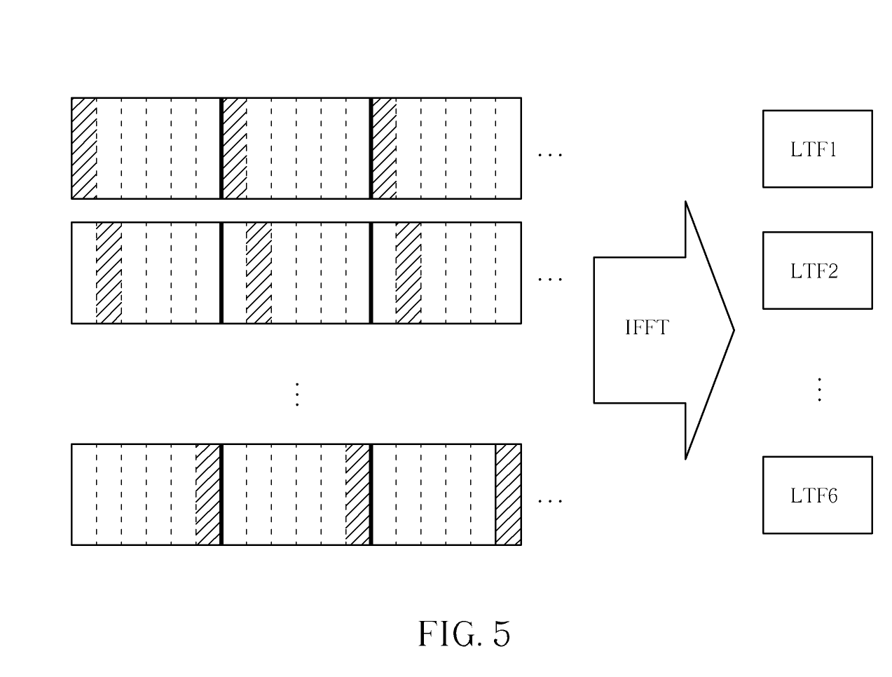

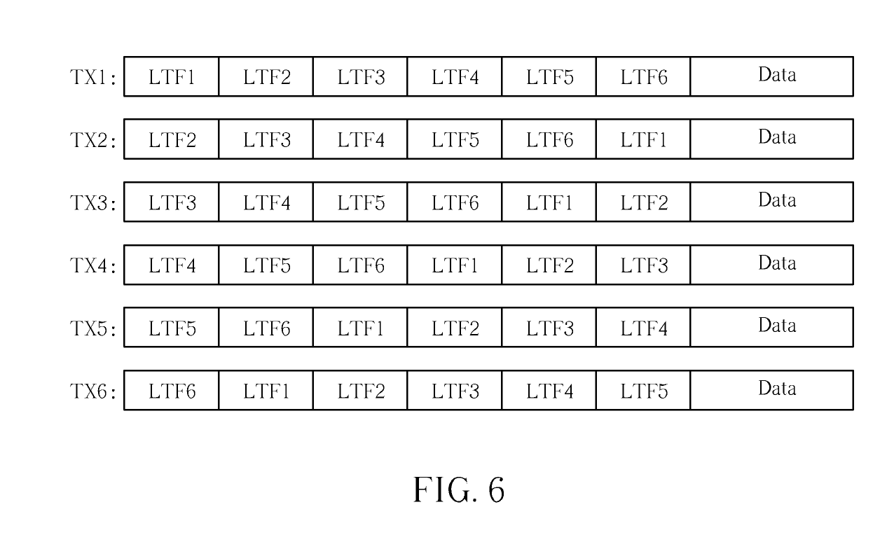

For clearly illustrating the training sequence generating process 40, a transmitter comprising six transmitting antennas (or transmitting routes) TX1-TX6 is taken as an example to show how to generate the corresponding training sequences, as shown in FIG. 5 and FIG. 6. In FIG. 5, continuous line blocks represent symbols, dot line blocks represent sub-symbols, oblique line areas represent selected sub-symbols, IFFT represents inverse discrete Fourier transform operation, and LTF1-LTF6 represent training data. Therefore, as can be seen from FIG. 5, each symbol is divided into six sub-symbols, and sub-symbols corresponding to same positions in the symbols are transformed to the training data LTF1-LTF6 via IFFT. That is to say, the training data LTF1 is obtained by performing IFFT to sub-symbols at the first places of all symbols, the training data LTF2 is obtained by performing IFFT to sub-symbols at the second places of all symbols, and so on.

Next, in FIG. 6, the training data LTF1-LTF6 are adequately arranged to be six training sequences, which are further carried in output packets emitted by the transmitting antennas TX1-TX6. Note that, FIG. 6 is utilized to show the contents of the training sequences; thus, other fields in the packets are omitted. In addition, as can be seen from FIG. 6, the transmitting antennas TX1-TX6 output different training data at the same time. For example, when the transmitting antenna TX1 transmits the training data LTF1, the transmitting antennas TX2-TX6 transmit the training data LTF2-LTF6. In other words, although the six training sequences illustrated in FIG. 6 are generated by arranging the training data LTF1-LTF6, the contents of the six training sequences at the same time are different. Such behavior is similar to an orthogonal feature of the frequency division multiplexing technique. Therefore, the receiver can easily execute an inverse operation, to perform channel estimation. More importantly, the quantity of training sequences equals the quantity of antennas, such that data to be transmitted in the multi-antenna system, especially the VHT wireless communication, can be efficiently decreased.

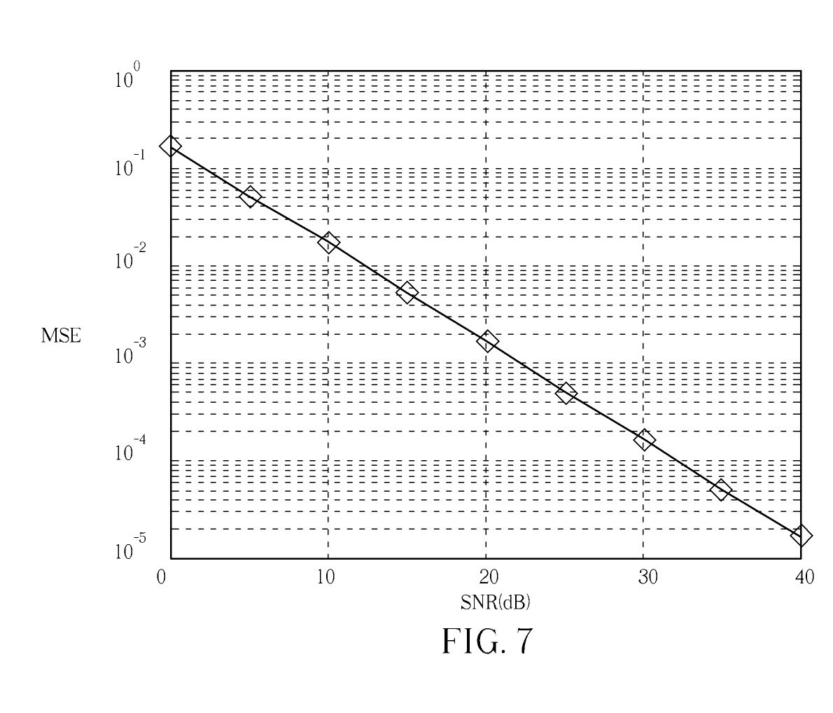

For evaluating the validity of the present invention, a simulation result in FIG. 7 can be obtained via an adequate simulation method, which represents a channel estimation result of a 6T2R (6 transmitter and 2 receiver) system. In FIG. 7, an x axis denotes signal to noise ratio (SNR), while a y axis denotes mean square error (MSE).

Note that, FIG. 5 and FIG. 6 are utilized for describing the spirit of the present invention, and those skilled in the art can make modifications accordingly. For example, when dividing the symbols, each symbol can be equally divided by a unit of sub-carrier. Nevertheless, if “equal division” cannot be realized, making the sub-symbols to be approximate large is also applicable.

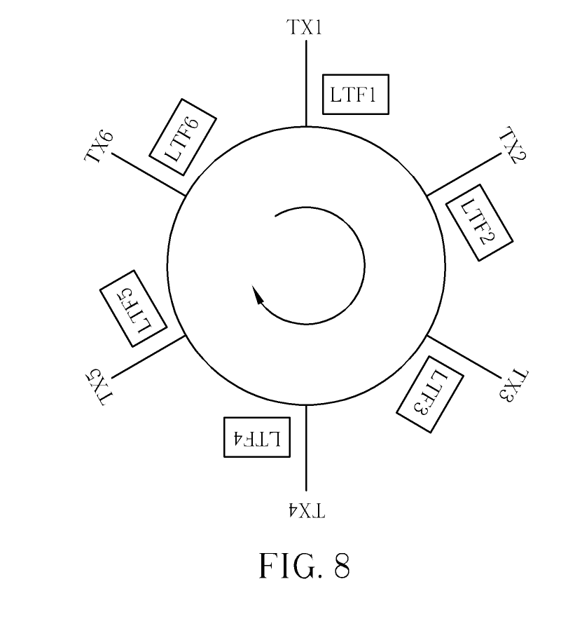

On the other hand, in the present invention, the arrangement or generation way of the training sequences can be varied, as long as each training sequence comprises all training data, and the contents of different training sequences at the same time are different. For example, as illustrated in FIG. 8, if the training sequences in FIG. 6 are to be generated, then a wrapped around chain can be applied by: corresponding the training data LTF1-LTF6 to the wrapped around chain, and setting starting points of transmitting antennas within the wrapped around chain according to each order of each transmitting antenna relative to other antennas. For example, the starting point of the transmitting antenna TX1 within the wrapped around chain is the training data LTF1 (the endpoint is the training data LTF6), the starting point of the transmitting antenna TX2 within the wrapped around chain is the training data LTF2 (the end point is the training data LTF1), and so on. Using the wrapped around chain, even if positions of two training data are exchanged (such as position of the training data LTF2 and LTF6 are exchanged), it can be ensured that each training sequence comprises all training data, and the contents of different training sequences at the same time are different. Certainly, FIG. 8 is a possible way to generate the training sequences, and other methods and devices that fulfill the same objective are applicable to the present invention.

Moreover, as to hardware realization, the training sequence generating process 40 can be transformed to a program with a format of software or firmware, and stored in a memory of a wireless communication device, for instructing a microprocessor to execute the steps of the training sequence generating process 40. Transforming the training sequence generating process 40 into an adequate program to realize a corresponding training sequence generating device should be an ordinary skill in the art.

For the next-generation wireless communication system, using the spreading code matrix for transforming the high-throughput long training fields in the prior art substantially increases overhead under a multi-antenna structure. In comparison, the quantity of the training sequences generated by the present invention is the same as that of the transmitting antennas. Hence, overhead can be reduced to enhance system efficiency.

To sum up, the present invention makes use of the orthogonal feature of the frequency division multiplexing technique, to generate the training sequences corresponding to different transmitting antennas, and ensures effective execution of channel estimation. More importantly, the quantity of the training fields carried by a packet equals the quantity of the transmitting antennas, such that data-to-be-transmitted in the multi-antenna system can be reduced, which is beneficial for the next-generation VHT wireless communication.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for generating training sequences in a transmitter having a plurality of transmitting antennas, comprising:
dividing each of a plurality of symbols into a plurality of sub-symbols with a quantity equal to a quantity of the plurality of transmitting antennas;
sequentially transforming a plurality of sub-symbols corresponding to same positions in each of the plurality of symbols, to generate a plurality of training data; and
generating a plurality of training sequences of independent frequencies according to the plurality of training data, for forming parts of packets emitted by the plurality of transmitting antennas.

2. The method of claim 1, wherein the step of dividing each of the plurality of symbols into the plurality of sub-symbols is dividing each of the plurality of symbols into the plurality of sub-symbols by a unit of a sub-carrier, to make sizes of the plurality of sub-symbols approximate.

3. The method of claim 1, wherein the step of sequentially transforming the plurality of sub-symbols corresponding to the same positions in each of the plurality of symbols is sequentially transforming the plurality of sub-symbols corresponding to the same positions in each of the plurality of symbols via an inverse discrete Fourier transform operation.

4. The method of claim 1, wherein the step of generating the plurality of training sequences of independent frequencies according to the plurality of training data comprises:
corresponding the plurality of training data to a wrapped around chain;
setting a starting point of each of the plurality of transmitting antenna within the wrapped around chain of each transmitting antenna according to an order of each transmitting antenna relative to other transmitting antennas; and
arranging the plurality of training data according to the wrapped around chain and the starting point of each of the transmitting antennas, to generate the plurality of training sequences of independent frequencies.

5. A transmitter having a plurality of transmitting antennas, comprising:
a microprocessor; and
a memory, for storing a program, for instructing the microprocessor to execute the following steps:
dividing each of a plurality of symbols into a plurality of sub-symbols with a quantity equal to a quantity of the plurality of transmitting antennas;
sequentially transforming a plurality of sub-symbols corresponding to same positions in each of the plurality of symbols, to generate a plurality of training data; and
generating a plurality of training sequences of independent frequencies according to the plurality of training data, for forming parts of packets emitted by the plurality of transmitting antennas.

6. The transmitter of claim 5, wherein the step of dividing each of the plurality of symbols into the plurality of sub-symbols is dividing each of the plurality of symbols into the plurality of sub-symbols, by a unit of a sub-carrier, to make sizes of the plurality of sub-symbols approximate.

7. The transmitter of claim 5, wherein the step of sequentially transforming the plurality of sub-symbols corresponding to the same positions in each of the plurality of symbols is sequentially transforming the plurality of sub-symbols corresponding to the same positions in each of the plurality of symbols via an inverse discrete Fourier transform operation.

8. The transmitter of claim 5, wherein the step of generating the plurality of training sequences of independent frequencies according to the plurality of training data comprises:
corresponding the plurality of training data to a wrapped around chain;
setting a starting point of each of the plurality of transmitting antenna within the wrapped around chain of each transmitting antenna according to an order of each transmitting antenna relative to other transmitting; and
arranging the plurality of training data according to the wrapped around chain and the starting point of each of the transmitting antennas, to generate the plurality of training sequences of independent frequencies.
